(19) United States
(12) Patent Application Publication
(10) Pub. No.: US 2024/0148187 A1
(43) Pub. Date: May 9, 2024

(54) HERB CUTTING TOOL HAVING INTERCHANGEABLE GRATES AND BLADES

(71) Applicant: Tyler Cantrell, Seattle, WA (US)

(72) Inventor: Tyler Cantrell, Seattle, WA (US)

(73) Assignee: Project Epoch LLC, Seattle, WA (US)

(21) Appl. No.: 18/395,246

(22) Filed: Dec. 22, 2023

Related U.S. Application Data
(60) Provisional application No. 62/348,881, filed on Jun. 11, 2016.

(51) Int. Cl. A47J 42/28; A47J 42/24; A47J 42/40

(52) U.S. Cl. CPC A47J 42/28; A47J 42/24; A47J 42/40

(57) ABSTRACT

An herb cutter having interchangeable grates and matching blades that includes a top chamber for holding herbs before cutting, a bottom chamber for holding herbs after cutting, and a grate positioned between the chambers is disclosed. The grate has multiple slots, each with at least one sharp or serrated edge. A rotatable rod extends across the grate, with a crank and handle connected to it. Multiple blades are attached to the rod, fitting within the slots to cut the herbs when the handle, crank, and rod are rotated. The slots and blades have corresponding lengths. The grate is a circular plate, and each blade is serrated with a central hole fitted about the rod. The cutter also includes spacers separating the blades, a middle shell and a lower funnel retaining the grate, and a lid covering the top chamber. The grate and blades are interchangeable.

### CROSS-REFERENCE TO RELATED APPLICATIONS

This application claims the benefit of priority to U.S. Provisional Application No. 61/348,881, filed on Dec. 23, 2022, which application is incorporated herein by reference in its entirety for all purposes.

### TECHNICAL FIELD

The present invention relates generally to culinary devices and, more specifically, to cutting, chopping, and/or grinding tools designed to cut, chop, tear, shear, shred, and/or grind plant-based materials into smaller sized particles.

### BACKGROUND OF THE INVENTION

Generally speaking, the term “herb” refers to a plant or a part of a plant that is valued for its flavor, fragrance, medicinal properties, or other useful qualities. In botanical terms, an herb is a plant that lacks a persistent woody stem above ground. Thus, herbs are typically characterized by their soft, non-woody stems, and they may be annuals, biennials, or perennials. Examples of botanical herbs include basil, parsley, and cilantro.

In a broader and more commonly used sense, the term “herb” refers to a subset of plants that are used for culinary, medicinal, or aromatic purposes. These plants are valued for their leaves, flowers, or other plant parts, which are used for flavoring food (culinary herbs), traditional medicine (medicinal herbs), or creating fragrances (aromatic herbs). In this context, the term “herb” may include plants with both woody and non-woody stems, such as rosemary and lavender.

An herb grinder is a device or tool used to tear apart and grind dry herbs, spices, or other plant materials into smaller, more manageable pieces. Herb grinders are commonly used in culinary applications for preparing herbs for cooking, as well as in the preparation of certain smoking materials, such as tobacco or legal smoking herbs. Herb grinders typically consist of two halves that can be separated. Each half typically has sharp teeth or pegs that interlock when the grinder is closed. The top and bottom halves are rotated against each other to shred, tear apart, and grind the herb material placed inside. When you grind herbs with a conventional herb grinder, the shredded and torn apart materials fall into a chamber below. Some grinders have multiple chambers separated by one or more screen of a selected mesh size that separates smaller processed materials from larger particles, allowing for a finer and better consistency of the processed herb product.

Conventional herb grinders, while effective at tearing apart and grinding herbs into smaller sized pieces, often pose a significant challenge when it comes to preserving the delicate nature of certain herbs. The primary issue lies in their design, which can inadvertently lead to unwanted crushing and damaging of the very herbs sought to be enhanced. For example, conventional herb grinders rely on sharp teeth or pegs to tear through and grind herbs, and this aggressive approach often results in unwanted crushing. Similarly, delicate herbs, such as basil or mint, are often susceptible to being overly compressed, causing a loss of essential oils and flavors. Unfortunately, conventional herb grinders, in their configuration and forceful tear-apart and grinding method, may compromise these essential elements. Indeed, the forceful grinding and crushing of herbs can lead to a more rapid release of volatile compounds, diminishing the overall quality of the herb. Finally, conventional herb grinders may produce inconsistent results, with some parts of the herb being more finely and/or unevenly ground while other parts remain largely intact.

Although some progress has been made over the years with respect to devices for cutting and/or grinding of raw herbs into smaller sized pieces, there is still a need in the art for new and improved tools that can selectively cut, chop, tear, shear, shred, and/or grind herbs and other plant-based materials into small size particles of a variety of different coarseness while preserving the aroma, flavor, and effectiveness of the processed herb products. The present invention fulfills these needs and provides for further related advantages.

### SUMMARY OF THE INVENTION

In brief, the present invention is directed to an herb cutting tool having interchangeable grates and blades. In an exemplary embodiment, the herb cutting tool comprises a top chamber with an upper opening and an interior top space configured to hold a selected herb before cutting, and a bottom chamber coupled to the top chamber, designed to hold the selected herb after cutting. A grate with a plurality of slots, each with at least one sharp edge, is positioned between the top and bottom chambers. A rotatable rod extends across and above the grate, positioned proximate and perpendicular to the slots. A crank connected to the rod and a handle connected to the crank are designed to transfer a circular motion to the rod. A plurality of blades attached to the rod are sized and configured to fit within the slots and cut the selected herb when the handle, the crank, and the rod are rotated.

Stated somewhat differently, the herb cutting tool of the present invention is designed for efficiently cutting herbs into a variety of different sized particles of a selected coarsness. It consists of a top chamber to hold the herb before cutting, a bottom chamber for the herb to fall into after cutting, and a grate with sharp edges positioned between them to facilitate the cutting. A rotatable rod, connected to a crank and handle, extends above the grate. Blades attached to the rod fit into the slots of the grate, allowing the selected herb to be cut when the handle is rotated. This tool provides a systematic and effective mechanism for non-aggressive cutting of herbs into different sized particles (for example, coarse and fine particles), enhancing the precision and convenience of the size reduction process.

These and other aspects of the present invention will become more readily apparent to those of ordinary skill in the art when reference is made to the following detailed description in view of the accompanying drawings.

### BRIEF DESCRIPTION OF THE DRAWINGS

The accompanying drawings illustrate several embodiments and different aspects of the present invention and, together with the detailed description, serve to explain certain principles and operation of the invention. It will be appreciated by those skilled in the art that the particular embodiments illustrated in the drawings and described herein are exemplary, and as such they do not limit the scope of the invention as established by the appended claims.

In the drawings like reference numerals are used to designate like features throughout the several views of the drawings

FIG. 1 is an elevated perspective view of an herb cutting tool in accordance with an embodiment of the present invention, wherein an H-shaped crank and handle are shown in a collapsed position.

FIG. 2 is an elevated perspective view of the herb cutting tool illustrated in FIG. 1 but wherein the H-shaped crank and handle are shown in an extended operating position.

FIG. 3 is a first side view of the herb cutting tool illustrated in FIG. 1 and shows, among other features, the configuration and attachment of an optional securing strap.

FIG. 4 is a second side view of the herb cutting tool illustrated in FIG. 1 and shows the configuration of the H-shaped crank and handle in a collapsed position.

FIG. 5 is a top plan view of the herb cutting tool illustrated in FIG. 1.

FIG. 6 is a bottom plan view of the herb cutting tool illustrated in FIG. 1.

FIG. 7 is an exploded perspective view of the herb cutting tool illustrated in FIG. 1 and shows the arrangement, configuration, and operational interrelationship of the various parts and components of the herb cutting tool.

FIG. 8 is a third side view of the herb cutting tool illustrated in FIG. 1 and shows the configuration of the H-shaped crank and handle when in a collapsed position.

FIG. 9 is a cross sectional view taken along line C-C of the herb cutting tool illustrated in FIG. 8 and shows the arrangement, configuration, and operational interrelationship of the various parts and components of the herb cutting tool.

FIG. 10 is a bottom perspective view of a middle shell of the herb cutting tool illustrated in FIG. 1 and shows a clasp and an aperture (for securely retaining the pivotal H-shaped crank and a rotatable rod, respectively, to the middle shell), as well as a plurality of middle shell section threads configured for interlocking and threaded engagement with matching parts.

FIG. 11 is a bottom perspective view of an internally positioned funnel of the herb cutting tool illustrated in FIG. 1, wherein the funnel includes a plurality of circumferentially positioned and inwardly curved indentations, as well as a plurality of funnel section threads configured for interlocking and threaded engagement with matching parts. In this configuration, the funnel is able to better direct cut herb product into the bottom chamber.

FIG. 12 is an elevated perspective view of a slotted grate with a series of blades fitted about a central rotatable rod positioned slightly above a top surface of the grate and perpendicular to the slots, wherein the series of blades are staggered relative to one another and spaced apart from one another by spacers in accordance with an embodiment of the present invention. As shown, the blades are offset relative to one another by about 45°.

FIG. 13 is a perspective view of the four different sizes of blades shown in FIG. 12, wherein each blade includes a series of opposing scythe-shaped cutting edges.

FIG. 14A is a top plan view of an exemplary slotted grate in accordance with an embodiment of the present invention, wherein each slot has a plurality of contiguous semi-circular cut-outs positioned along the edges of the slots, and wherein the plurality of semi-circular cut-outs yield, after cutting, a finished cut product having a first particle size distribution and coarseness profile.

FIG. 14B is a side perspective view of the slotted grate illustrated in FIG. 14A.

FIG. 15A is a top plan view of an exemplary slotted grate in accordance with another embodiment of the present invention, wherein each slot has a plurality of triangular-shaped cut-outs positioned along the edges of the slots, and wherein the plurality of triangular-shaped cut-outs yield, after cutting, a finished cut product having a second particle size distribution and coarseness profile.

FIG. 15B is a side perspective view of the slotted grate illustrated in FIG. 15A.

FIG. 16A is a top plan view of an exemplary slotted grate in accordance with yet another embodiment of the present invention, wherein each slot has a plurality of circular cut-outs positioned along the edges of the slots, wherein the plurality of circular cut-outs are of two different small sizes corresponding to a finished cut product of two different particle sizes, and wherein the plurality of two different sizes of circular cut-outs yield, after cutting, a finished cut product having a third particle size distribution and coarseness profile.

FIG. 16B is a side perspective view of the slotted grate illustrated in FIG. 16A.

FIG. 17A is a top plan view of an exemplary slotted grate in accordance with yet another embodiment of the present invention, wherein each slot has a plurality of circular cut-outs of a first small size positioned along the edges of the slots, and wherein the plurality of circular cut-outs yield, after cutting, a finished cut product having a fourth particle size distribution and coarseness profile.

FIG. 17B is a side perspective view of the slotted grate illustrated in FIG. 17A.

FIG. 18A is a top plan view of an exemplary slotted grate in accordance with yet another embodiment of the present invention, wherein each slot has a plurality of circular cut-outs of a second small size positioned along the edges of the slots, and wherein the plurality of circular cut-outs yield, after cutting, a finished cut product having a fifth particle size distribution and coarseness profile.

FIG. 18B is a side perspective view of the slotted grate illustrated in FIG. 18A.

FIG. 19A is a side profile view of an exemplary slotted grate in accordance with yet another embodiment of the present invention, wherein the grate has top and bottom major surfaces that are substantially flat, wherein the lengthwise edges of each slot protrude slightly above and below the top and bottom major surfaces of the grate, and wherein the lengthwise edges on either side of a centerline are slanted at an approximate 45° angle toward the centerline. The slotted grated of this embodiment yields, after cutting, a finished cut product having a sixth particle size distribution and coarseness profile, wherein the sixth coarseness profile consists essentially of about 50% course cut pieces and about 50% fine cut pieces.

FIG. 19B is a top plan view of the slotted grate illustrated in FIG. 19A.

FIG. 19C is a perspective view of the slotted grate illustrated in FIG. 19A and FIG. 19B.

FIG. 20A is a side profile view of an exemplary slotted grate in accordance with yet another embodiment of the present invention. The slotted grated of this embodiment yields, after cutting, a finished cut product having a seventh coarseness profile, wherein the seventh particle size distribution and coarseness profile consists essentially of about 20% course cut pieces and about 80% fine cut pieces.

FIG. 20B is a top plan view of the slotted grate illustrated in FIG. 20A.

FIG. 20C is a perspective view of the slotted grate illustrated in FIG. 20A and FIG. 20B.

FIG. 21A is a side profile view of an exemplary slotted grate in accordance with yet another embodiment of the present invention. The slotted grated of this embodiment yields, after cutting, a finished cut product having a eighth coarseness profile, wherein the eighth particle size distribution and coarseness profile consists essentially of about 80% course cut pieces and about 20% fine cut pieces.

FIG. 21B is plan view of the slotted grate illustrated in FIG. 21A.

FIG. 21C is a perspective view of the slotted grate illustrated in FIG. 21A and FIG. 21B.

### DETAILED DESCRIPTION OF THE INVENTION

In the following detailed description, reference is made to the accompanying drawings, which form a part hereof. In the drawings, similar symbols or markings have been used to identify like or corresponding parts or elements, unless context dictates otherwise. The illustrative embodiments described and illustrated in the detailed description and drawings are not meant to be limiting and are not necessarily to scale. Rather, other embodiments may be utilized, and other changes may be made, without departing from the scope of the invention as defined by the appended claims.

In the context of the present invention, the term “herb” is used in its broadest sense and means any plant or plant part used for culinary, medicinal, or aromatic purposes. Similarly, the term “cutting” broadly refers to any action that uses a tool or implement to separate or divide an object into two or more pieces and, therefore, encompasses several closely analogous terms such as, for example, the terms “chopping” and “grinding”.

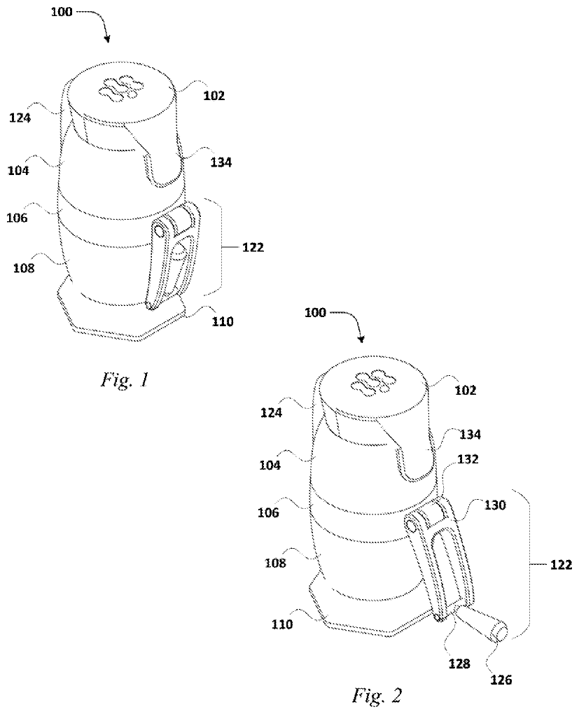

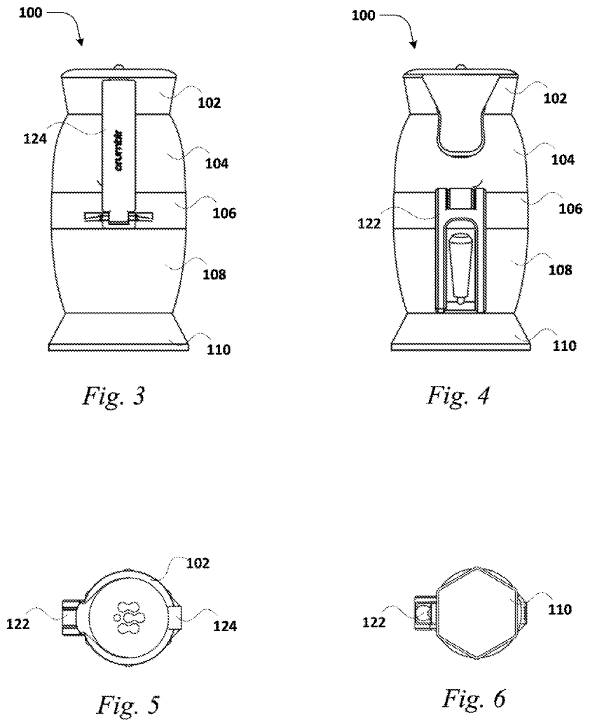

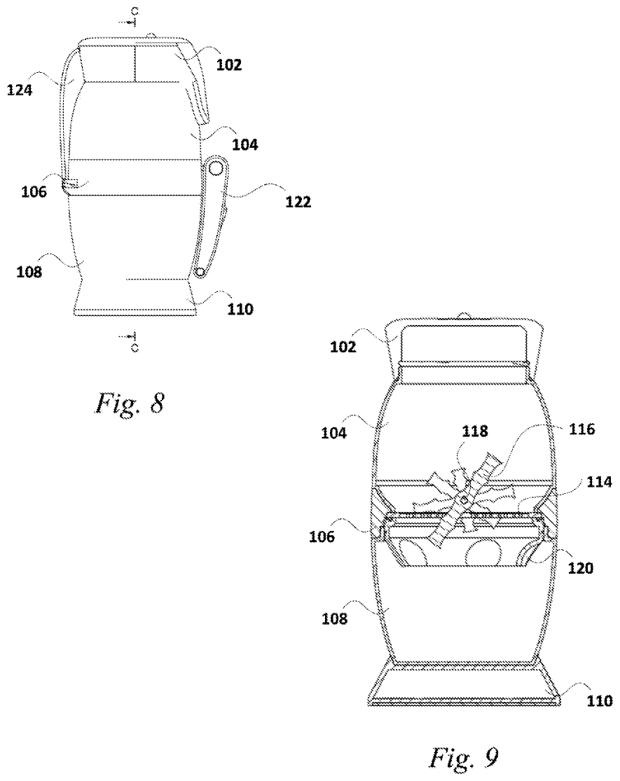

Referring now to the drawings wherein like reference numerals are used to designate like parts and features and, more particularly, to FIGS. 1-9, the present invention in an exemplary embodiment is directed to an herb cutting tool 100 that includes interchangeable slotted grates 114 having different slot patterns and interchangeable sharp-edged blades 116 having different lengths and edge profiles. In combination, the slotted grates 114 and corresponding blades 116 are designed to work together to efficiently cut a selected herb (not shown) into a finished herb product of a selected uniformity and coarseness (depending on the grate and blade selections). Thus, the herb cutting tool 100 of the present invention is readily configurable to cut selected herbs into a finished products having a variety of different particle size distributions and coarseness profiles (such as, for example, a finished herb product having a coarseness profile consisting essentially of two different shaped and sized cut materials). Unlike conventional herb grinders, the grate 114 and the plurality of blades 116 of the inventive herb cutting tool 100 are readily interchangeable with other grates and other blades, respectively. Preferably, but not necessarily, the interchangeable grates 114 and blades of the present invention are made of stainless steel.

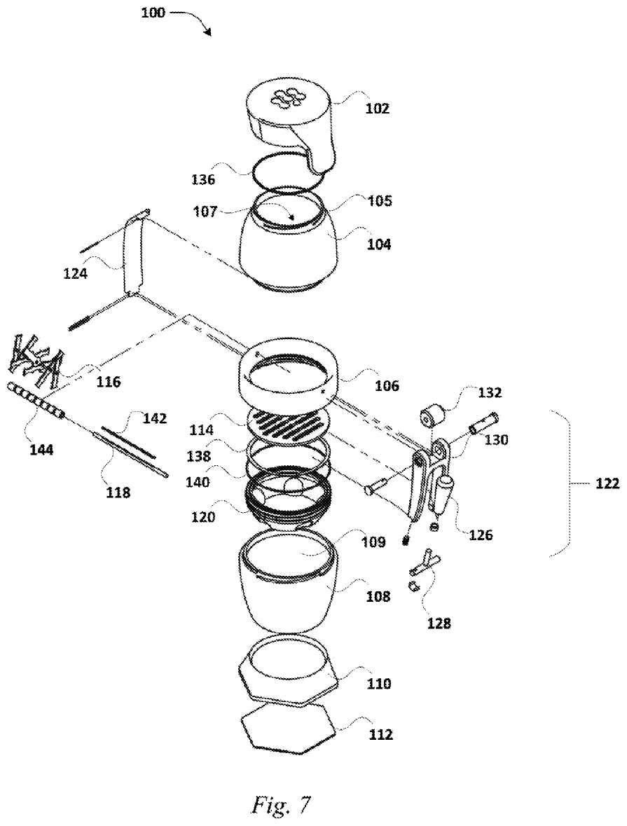

As best shown in FIG. 7, the herb cutting tool 100 of the present invention comprises a top chamber 104 having an upper opening 105 and an interior top space 107 sized and configured to hold the selected herb before being cut into smaller pieces. A bottom chamber 108 is coupled to the top chamber 104. The bottom chamber 108 includes an interior bottom space 109 sized and configured to hold the selected herb after being cut into smaller pieces. A plate or disc-shaped grate 114 is positioned between the top chamber 104 and the bottom chamber 108. The grate 114 includes a plurality of slots 154 with each slot 154 being parallel to one another and having edges 154a that may be sharp and/or serrated. A rotatable rod 118 extends across and slightly above the grate 114 with the rod 118 being positioned proximate and perpendicular to the plurality of slots 154. A crank 130 connects to the rod 118. A handle 122 connects to the crank 130 with the handle 122 being configured to transfer a circular motion (imparted by a user) to the rod 118 via the crank 130. The crank 130 is preferably in the form of a H-shaped frame having a lower section and an upper section, wherein the lower section is pivotally connected to the rod 118 and the upper section is pivotally connected to the handle 122. As shown, a plurality of blades 116 are fitted about the rod 118. The plurality of blades 116 are sized and configured to fit within the plurality of slots 154 and cut the selected herb when the handle 122, the crank 130, and the rod 118 are rotated in unison by a user.

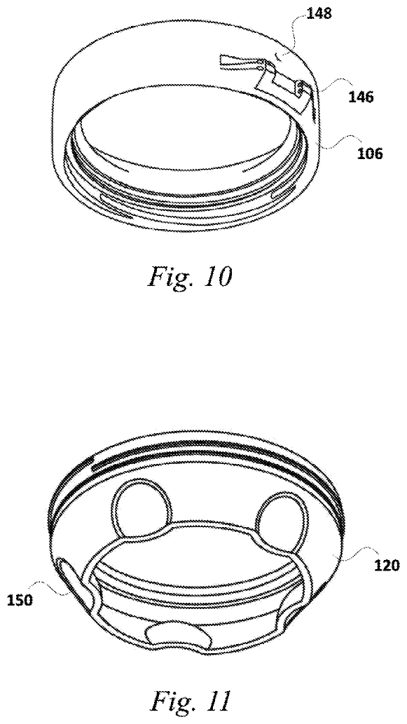

As further shown, the herb cutting tool 100 also includes a middle shell 106 (shown in isolation of FIG. 10) and a lower funnel 120 (shown in isolation in FIG. 11). The middle shell 106 is positioned between the top chamber 104 and the bottom chamber 108 with the rod 118 extending through the middle shell 106 via opposing apertures 148. In addition, the selected grate 114 is positioned between the middle shell 106 and the lower funnel 120 such that the lower funnel 120 nests within the bottom chamber 108. When assembled, the middle shell 106 is threadedly engaged to both the funnel 120 and the bottom chamber 108 thereby retaining the grate 114 therebetween. In addition, the top chamber 104 is threadedly engaged to the middle shell 106 and a lid 102, in turn, is threadedly engaged to the top chamber 104 so as to cover the upper opening 105.

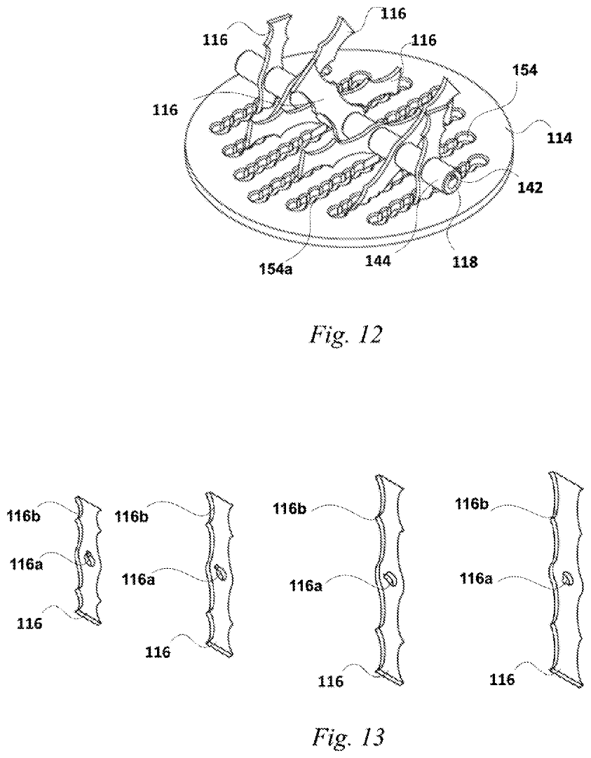

As best shown in FIG. 12 and FIG. 13, the plurality of slots 154 and the plurality of blades 116 preferably have different lengths that match and correspond to each other. Preferably, each blade 116 of the plurality of blades 116 includes a series of sharp, serrated, and/or scythe-shaped cutting blade edges 116a. The herb cutting tool 100 preferably also includes a plurality of spacers 144 fitted about the rod 118 and configured to separate the plurality of blades 116 from one another along the rod 118. The grate 114 may be in the form of a flat circular plate, and each blade 116 has a central hole 116b fitted about the rod 118. The central hole 116b of each blade 116 may be any number of different shapes such as, for example, a circular-shape, a semi-circle shape, a triangle shape, a star shape, a diamond shape, or a square shape. The blades 154 may be staggered and offset from each other a selected angular amount, such as, for example and as shown, by about 45°. The lengthwise edges 154a of each slot 154 may be defined by a plurality of “cut-outs”. Each cut-out may be any desired shape (depending on the user's desired cut herb product particle size distribution and coarseness profile) such as, for example, a circular-shape, a semi-circle shape, a triangle shape, a diamond shape, a square shape, or a combination thereof.

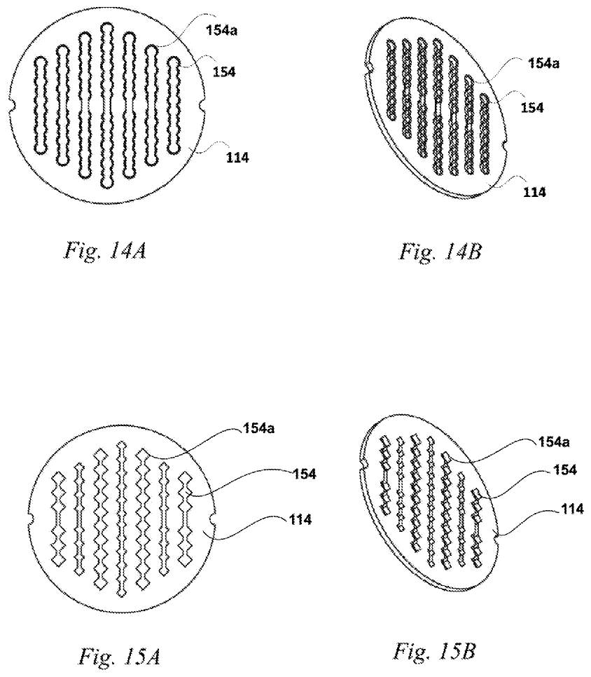

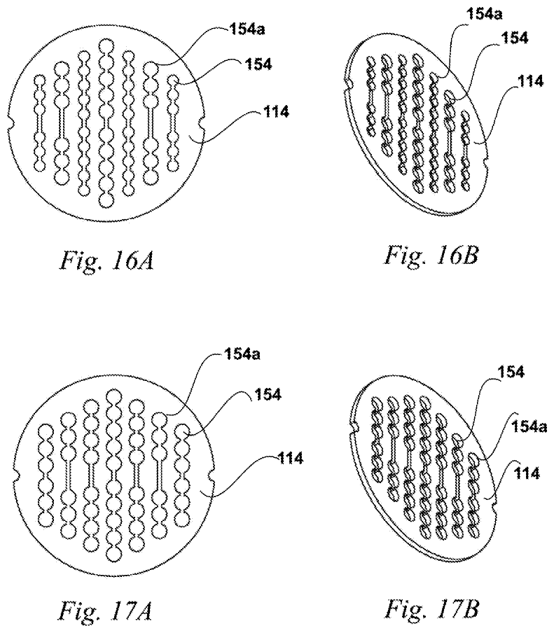

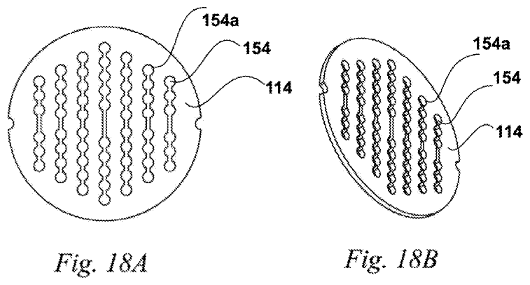

FIG. 14A through FIG. 18B show a first set of different grates 114 having different slot patterns useful for the practice of the present invention. As shown, each grate 114 includes a plurality of slots 154 with each slot have a unique “cut-out” pattern positioned along the edges 154a of the slots 154. Because the cut-out patterns of each grate 114 is unique, the herb cutting tool 100 can yield, after cutting, a finished cut product having a user selected particle size distribution and coarseness profile.

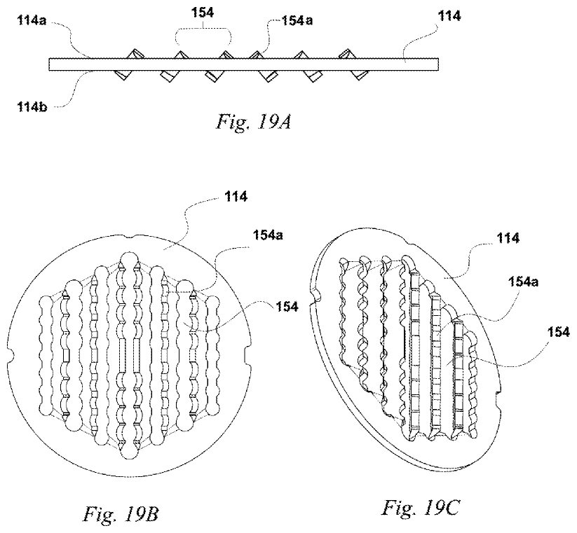

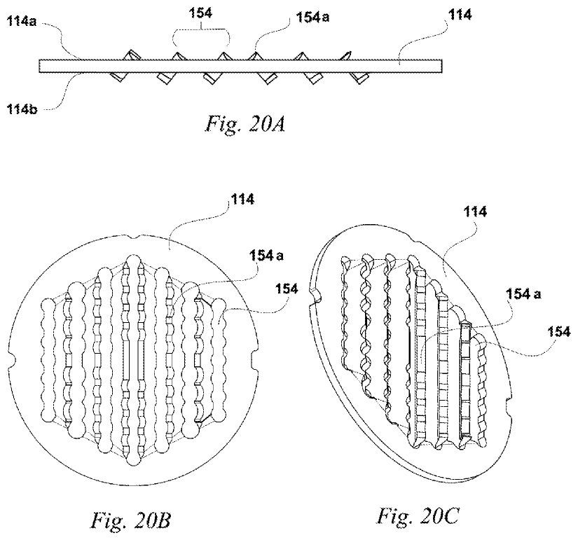

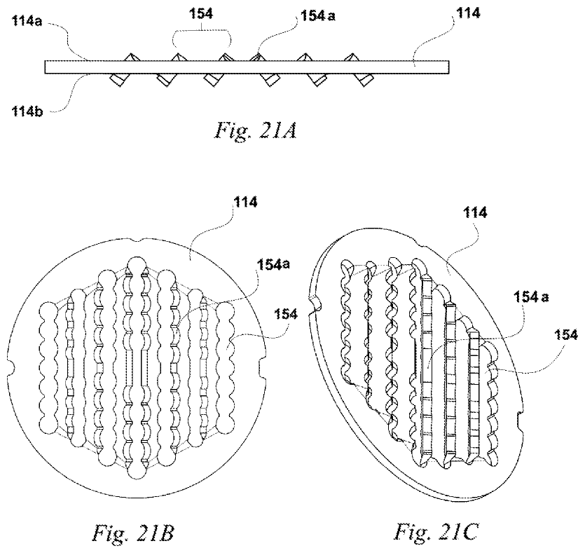

FIG. 19A through FIG. 20C show a second set of different grates 114 having different slot patterns useful for the practice of the present invention. As shown, each grate 114 includes a plurality of slots 154 with each slot also having a unique “cut-out” pattern positioned along the edges 154a of the slots 154. In addition, and as further shown, the grate 114 in these further embodiments, has top 114a and bottom 114b major surfaces that are substantially flat, and wherein the lengthwise edges 154a of each slot 154 protrude above and below the top 114a and bottom 114b major surfaces of the grate 114. The grate has an inherent centerline and the protruding lengthwise edges 154a are preferably symmetric about the centerline. As with the first set of different grates 114, and because the cut-out patterns of each grate 114 of the second set of different grates 114 is unique, the herb cutting tool 100 can yield, after cutting, a finished cut product having a user selected particle size distribution and coarseness profile.

As an aid to a fuller understanding of the present invention and all of its features, the following parts and features list identifies most all of the parts and features of the exemplary herb cutting tool 100 described and illustrated herein.

### LISTING OF DRAWING ELEMENTS

100— Herb cutting tool
102— Lid
104— Top chamber
105— Opening
106— Middle shell
107— Interior top space
108— Bottom chamber
109— Interior bottom space
110— Bottom base
112— Bottom cover
114— Grate
114a— Top surface of grate
114b— Bottom surface of grate
116— Blades
116a— Blade edge
116b— Central hole
118— Rod
120— Funnel
122— Handle
124— Strap
126— Handle grip
128— Lower pivot T-rod
130— H-shaped crank
132— Connector
136— Upper O-ring
138— Sealing ring
140— Lower O-ring
142— Blade key
144— Spacer
146— Clasp
148— Aperture
150— Indentation
154— Slot
154a— Slot edge

While the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing description, and all changes that come within the meaning and range of equivalency of the claims are to be embraced within their scope.

What is claimed is:

1. An herb cutting tool configured for cutting or grinding a selected herb to yield a finished herb product having a selected particle size distribution and coarseness profile, comprising:
a top chamber having an upper opening and an interior top space sized and configured to hold a selected herb before cutting;
a bottom chamber coupled to the top chamber, the bottom chamber having an interior bottom space sized and configured to hold the selected herb after cutting;
a grate positioned between the top chamber and the bottom chamber, the grate having a plurality of slots, wherein each slot is parallel to one another and has at least one edge;
a rotatable rod extending across and above the grate, wherein the rod is positioned proximate and perpendicular to the plurality of slots;
a crank connected to the rod;
a handle connected to the crank, wherein the handle is configured to transfer a circular motion to the rod via the crank; and,
a plurality of blades attached to and about the rod, wherein the plurality of blades are sized and configured to fit within the plurality of slots and cut the selected herb when the handle, the crank, and the rod are rotated.

2. The herb cutting tool of claim 1 wherein the plurality of slots and the plurality of blades have different lengths matched and corresponding with each other.

3. The herb cutting tool of claim 2 wherein each blade of the plurality of blades includes a series of scythe-shaped cutting edges.

4. The herb cutting tool of claim 2 wherein the grate is in the form of a flat circular plate, and wherein each blade of the plurality of blades is serrated and has a central hole fitted about the rod.

5. The herb cutting tool of claim 2 wherein the plurality of blades are in a staggered formation about the rod.

6. The herb cutting tool of claim 5 wherein the at least one edge of each slot is serrated.

7. The herb cutting tool of claim 5 wherein the blades are offset from each other by about 45°.

8. The herb cutting tool of claim 5, and wherein the central hole of each blade has a circular-shape, a semi-circle shape, a triangle shape, a star shape, a diamond shape, or a square shape.

9. The herb cutting tool of claim 5 wherein the at least one serrated edge of each slot of the plurality of slots is defined by a plurality of cut-outs positioned along the lengthwise edges of each slot.

10. The herb cutting tool of claim 9 wherein each cut-out of the plurality of cut-outs has a circular-shape, a semi-circle shape, a triangle shape, a diamond shape, a square shape, or a combination thereof.

11. The herb cutting tool of claim 9 wherein the grate has top and bottom major surfaces that are substantially flat, and wherein the lengthwise edges of each slot protrude above and below the top and bottom major surfaces of the grate.

12. The herb cutting tool of claim 10, further comprising a plurality of spacers fitted about the rod and separating the plurality of blades from one another along the rod.

13. The herb cutting tool of claim 12, further comprising a middle shell and a lower funnel, wherein the grate is positioned between the middle shell and the lower funnel, wherein the lower funnel is nested within the bottom chamber, wherein the middle shell is threadedly engaged to the funnel and the bottom chamber thereby retaining the grate therebetween, wherein the middle shell is positioned between the upper chamber and the lower chamber, and wherein the rod extends through the middle shell.

14. The herb cutting tool of claim 13 wherein the top chamber is threadedly engaged to the middle shell, and further comprising a lid covering the upper opening and threadedly engaged to the top chamber.

15. The herb cutting tool of claim 14 wherein the crank is in the form of a H-shaped frame having a lower section and an upper section, and wherein the lower section is pivotally connected to the rod and the upper section is pivotally connected to the handle.

16. The herb cutting tool of claim 15 wherein the grate and the plurality of blades are interchangeable with other grates and other blades, respectively.

17. The herb cutting tool of claim 1 wherein each slot of the plurality of slots has lengthwise edges protruding above and below the top and bottom major surfaces of the grate.

18. The herb cutting tool of claim 17 wherein the grate has a centerline, and wherein the protruding lengthwise edges are symmetric about the centerline.

19. The herb cutting tool of claim 1 wherein the selected particle size distribution and coarseness profile ranges from about 20% to 80% course cut pieces and about 20% to 80% fine cut pieces.

20. The herb cutting tool of claim 1 wherein the selected particle size distribution and coarseness profile consists essentially of about 50% course cut pieces and about 50% fine cut pieces.
